(19) United States
(12) Patent Application Publication
(10) Pub. No.: US 2024/0324604 A1
(43) Pub. Date: Oct. 3, 2024

(54) PHYTOTHERAPEUTIC COMPOSITIONS FOR ENDOTHERAPY

(71) Applicant: NDG NATURAL DEVELOPMENT GROUP S.R.L., Castel Maggiore (BO) (IT)

(72) Inventors: Massimo Piva, Castel Maggiore (BO) (IT); Gianluca Manfredini, Castel Maggiore (BO) (IT); Stefania Manfredini, Castel Maggiore (BO) (IT); Valerio Borzatta, Bologna (IT); David Baldo, Laives (BZ) (IT); Eleonora Cappelletti, Chiusa (BZ) (IT); Maresa Novara, Incisa Scapaccino (AT) (IT); Fabio Dino, Incisa Scapaccino (AT) (IT); Matteo Coletti, Moscow (RU)

(73) Assignee: NDG NATURAL DEVELOPMENT GROUP S.R.L., Castel Maggiore (BO) (IT)

(21) Appl. No.: 18/580,477

(22) PCT Filed: Jul. 21, 2022
(86) PCT No.: PCT/EP2022/070480

§ 371 Date: Jan. 18, 2024

(30) Foreign Application Priority Data
Jul. 22, 2021 (IT) 102021000019568

(51) Int. Cl. A01N 65/22; A01N 59/16; A01N 59/20; A01N 59/26; A01N 65/10; A01N 65/24; A01N 65/28; A01N 65/36; A01N 65/42; A01P 1/00

(52) U.S. Cl. CPC A01N 65/22; A01N 59/16; A01N 59/20; A01N 59/26; A01N 65/10; A01N 65/24; A01N 65/28; A01N 65/36; A01N 65/42; A01P 1/00

(57) ABSTRACT

The present invention relates to the use of a phytotherapeutic composition comprising:—a carbonate substituted hydroxyapatite having the formula (I): Ca_{(10-y/2)}(PO₄)_{(6-y)}(CO₃)_{y}(OH)₂ (I) wherein y is comprised between 0.01 and 2: and—at least one bioactive compound selected from the group consisting of: anaromatic plant extract and/or an active substance thereof, a metal ion, and acarboxylic acid; as phytotherapeutic agent for the endotherapeutic treatment of a plant.

### FIELD OF THE INVENTION

The present invention relates to compositions of carbonate-substituted hydroxyapatite containing at least one bioactive compound for the endotherapeutic treatment of a plant.

### BACKGROUND

In agriculture pesticides are largely used to preserve the plants from suffering different diseases caused by fungi, bacteria, and insect attack. On the other hand more and more attention has been devoted to the use of pesticides, in particular to avoid the pollution of the environment taking different approaches In this scenario, in 2009 European Parliament approved an important directive about the sustainable use of pesticides, the DIRECTIVE 2009/128/EC. The Article 9 emphasizes that aerial spraying of pesticides should have to be minimized due to drift effect which would damage the environment and human health. Furthermore traditional plant protection treatments applied to the tree's foliage only allow a minimum percentage of the solution containing the active substance to actually reach the “target” to perform its functions. Alternative approaches such as Integrated Pest Management have to be considered, such as the use of formulations able to reach the plant target sites and the insects in a defined way. Among these approaches, endotherapy is an application suitable for no contamination of the environment. Infact the endotherapeutic intervention consists of introducing into the vital part of the stem, i.e in the outermost part, small quantities of active ingredients which attack the parasites, eliminating them from the inside without affecting the aerial vegetation. This is made possible by the xylematic sap: by moving from the roots to the foliage through channels called xylematic vessels, the xylematic sap carries water and minerals into every part of the plant. With the same principle nutrients can be fed to the plant, especially if it is in a state of stress. So the endotherapy is a method for treating arboreal plants by means of phytotherapeutic formulations providing protection against parasite, fungal and/or bacterial attacks by injecting the phytoterapeutic formulations inside the trunk of the plant. In addition to drastically reducing the amount of plant protection products used, the practice of endotherapy saves the surrounding environment and “non-target” organisms from exposure to chemical molecules. In addition, soil and groundwater are preserved from pollution caused by drift and runoff, so that the benefits of treatment are much more durable than traditional spraying.

Neverthless endotherapeutic treatments of a plants can be considered as invasive by itself. Infact holes are made in the trunk of different diameter and leaving a separation between them of different length. The smaller the diameter of the hole, the faster the wound heals (Perry et al., 1991). The use of drilling methods has negative side effects such as loss of functionality of adjacent woody tissues and delayed hole closure. Furthermore the actives are injected by using different methods that can be so summarized: by gravity, by micropressure and by pressure. Each method presents some advantages and disadvantages, but in any case the efficay of the actives has to be high so as to minimize the possible effect of the plant stress due to the time of injection and the condition (pressure) of the injection.

So the efficay of the used actives plays a fundamental role in reducing high quantities or high volumes of actives that could alter the state of the plant. Therefore the need to have compositions capable of efficiently providing pesticide action to be used in plant endotherapy is particulary felt.

### SUMMARY OF THE INVENTION

The Applicant surprisingly found out that a phytotherapeutic composition based on carbonate substituted hydroxyapatite as a carrier and including bioactive compounds may be effectively and easily used in plant endotherapy allowing an effective treatment of plant pathologies through its direct injection into the vital part of the stem and without affecting the aerial vegetation of the plant.

The present invention, therefore, in a first aspect refers to the use of a phytotherapeutic composition comprising:
a carbonate substituted hydroxyapatite having the formula (I):

Ca_{(10-y/2)}(PO₄)_{(6-y)}(CO₃)_{y}(OH)₂ (I)
wherein y is comprised between 0.01 and 2; and
at least one bioactive compound selected from the group consisting of: an aromatic plant extract and/or an active substance thereof, a metal ion, and a carboxylic acid;
   as phytotherapeutic agent for the endotherapeutic treatment of a plant.

The Applicant has indeed surprisingly found out that the specific combination of the carbonate substituted hydroxyapatite of formula (I) above with bioactive compounds exhibit significant broader and greater phytotherapeutic activity than the substances alone or incomplete mixtures of them. Combining carbonate substituted hydroxyapatite of formula (I) above with bioactive compounds selected from the group consisting of: an aromatic plant extract and/or an active substance thereof, a metal ion, and a carboxylic acid, surprisingly enhances the phytotherapeutic activity of said bioactive compounds and thereby allow formulations with lower bioactive compounds concentrations that are still effective. Lower concentrations of bioactive active substances also have many other positive effects for biocompatibility, practical applications and commercial aspects and in such a way it is possible to combine the positive effect of little or no environmental contamination with the concomitant use of reduced dosages of bioactive ingredients.

The Applicant has also surprisingly found out a beneficial fertilizing effect on the plants treated with the phytotherapeutic composition according to the invention, thus reducing the need thereof of being fertilized with separate treatments. As the excessive use of fertilizers created environmental concerns linked to the accumulation and undesided presence of fertilizers in soil and fresh waters, the Applicant felt that the carbonate substituted hydroxyapatite of formula (I) above, being by itself of natural origin, actively contributed therefore to additionally limit the enviromental impact connected with the cultivation of the treated plants.

### DETAILED DESCRIPTION OF THE INVENTION

The present invention refers, in a first aspect, to the use of a phytotherapeutic composition comprising:
a carbonate substituted hydroxyapatite having the formula (I):

Ca_{(10-y/2)}(PO₄)_{(6-y)}(CO₃)_{y}(OH)₂ (I)
wherein y is comprised between 0.01 and 2; and
at least one bioactive compound selected from the group consisting of: an aromatic plant extract and/or an active substance thereof, a metal ion, and a carboxylic acid;
   as phytotherapeutic agent for the endotherapeutic treatment of a plant.

That is, the present invention refers to a method for the endotherapeutic treatment of a plant comprising the step of using as phytotherapeutic agent a phytotherapeutic composition comprising:
a carbonate substituted hydroxyapatite having the formula (I):

Ca_{(10-y/2)}(PO₄)_{(6-y)}(CO₃)_{y}(OH)₂ (I)
wherein y is comprised between 0.01 and 2; and
at least one bioactive compound selected from the group consisting of: an aromatic plant extract and/or an active substance thereof, a metal ion, and a carboxylic acid.

The Applicant has indeed surprisingly found out that a phytotherapeutic composition based on carbonate substituted hydroxyapatite as a carrier and including bioactive compounds may be effectively and easily used in plant endotherapy allowing an effective treatment of plant pathologies through its direct injection into the vital part of the stem and without affecting the aerial vegetation of the plant.

Notably, the specific combination according to the present invention of a carbonate substituted hydroxyapatite of formula (I) above with bioactive compounds exhibit significant broader and greater phytotherapeutic activity than the substances alone or incomplete mixtures of them. Combining carbonate substituted hydroxyapatite of formula (I) above with bioactive compounds selected from the group consisting of: an aromatic plant extract and/or an active substance thereof, a metal ion, and a carboxylic acid, surprisingly enhances the phytotherapeutic activity of said bioactive compounds and thereby allow formulations with lower bioactive compounds concentrations that are still effective. Lower concentrations of bioactive active substances also have many other positive effects for biocompatibility, practical applications and commercial aspects and in such a way it is possible to combine the positive effect of little or no environmental contamination with the concomitant use of reduced dosages of bioactive ingredients.

The Applicant has also surprisingly found out a beneficial fertilizing effect on the plants treated with the phytotherapeutic composition according to the invention, thus reducing the need thereof of being fertilized with separate treatments. As the excessive use of fertilizers created environmental concerns linked to the accumulation and undesided presence of fertilizers in soil and fresh waters, the Applicant felt that the carbonate substituted hydroxyapatite of formula (I) above, being by itself of natural origin, actively contributed therefore to additionally limit the enviromental impact connected with the cultivation of the treated plants.

Within the framework of the present description and in the subsequent claims, except where otherwise indicated, all the numerical entities expressing amounts, parameters, percentages, and so forth, are to be understood as being preceded in all instances by the term “about”. Also, all ranges of numerical entities include all the possible combinations of the maximum and minimum values and include all the possible intermediate ranges, in addition to those specifically indicated herein below.

In the context of the present application, the expression “endotherapeutic treatment of a plant” or “plant endotherapy” indicates a method of targeting a precise application of bioactive compounds (for example pesticides, plant resistance activators, or fertilizers) into the xylem vascular tissue of a plant with phytotherapeutic purposes. “Tree injection”, “trunk injection” and “stem injection” are all synonyms of plant endotherapy and of endotherapeutic treatment of a plant.

The present invention may present in one or more of the above aspects one or more of the characteristics disclosed hereinafter.

The phytotherapeutic composition according to the present invention comprises a carbonate substituted hydroxyapatite having the formula (I):

Ca_{(10-y/2)}(PO₄)_{(6-y)}(CO₃)_{y}(OH)₂ (I)

wherein y is comprised between 0.01 and 2.

Preferably, y is comprised between 0.1 and 1.2 more preferably between 0.2 and 0.8.

Preferably, the phytotherapeutic composition according to the invention comprises, with respect to the weight of the phytotherapeutic composition, from 0.5% to 40% by weight, more preferably from 1% to 15% by weight, and optimally 1.5% to 10% by weight of said carbonate substituted hydroxyapatite.

Preferably, said carbonate substituted hydroxyapatite has a crystallinity degree comprised between 25% and 59%, more preferably between 25% and 40%.

Said crystallinity degree may be determined by XRD measures as in Landi E., J. Europ. Ceramic Soc. 23 (2003),2931-2937.

The phytotherapeutic composition according to the present invention comprises at least one bioactive compound selected from the group consisting of: an aromatic plant extract and/or an active substance thereof, a metal ion, and a carboxylic acid.

The phytotherapeutic composition according to the present invention may therefore comprise an aromatic plant extract and/or an active substance thereof as bioactive compound.

Preferably, in the phytotherapeutic composition according to the invention the weight ratio of said aromatic plant extract and/or active substance thereof with respect to the weight of the carbonate substituted hydroxyapatite is from 0.1 to 3, more preferably from 0.3 to 2, even more preferably from 0.5 to 2.

Preferably, said aromatic plant extract and/or active substance thereof is selected from the group consisting of extracts and/or active substances from extracts of Abies sibirica, Malpighia glabra, Achillea millefolium. Allium sativum, Medicago sativa, Aloe vera, Artemisia annua, Arnica Montana, Ocimum basilicum, Betula pendula, Betula pubescens, Calendula officinalis, Chrysanthemum cinerariaefolium, Tanacetum cinerariaefolium, Chrysanthemum coccineum, Chrysanthemum balsamita, Chrysanthemum roseum, Chrysanthemum marshall, Matricaria chamomilla, Chamaemelum nobile, Cinnamomum verum, Centella asiatica, Chelidonium majus, Syzygium aromaticum, Allium cepa, Equisetum arvense, Curcuma longa, Echinacea purpurea, Echinacea angustifolia, Eucalyptus globulus, Hypericum perforatum, Fucus vesiculosus, Glycine max, Glycyrrhiza glabra, Gentiana lutea, Lavandula angustifolia, Linen seed, Melilotus officinalis, Melissa officinalis, Punica granatum, Mentha piperita, Vaccinium myrtillus, Origanum vulgaris, Orthosiphon stamineus, Urtica dioica, Olea europeae, Tabebuia impetiginosa, Plantago lanceolata, Hieracium pilosella, Pinus sibirica, Polypodium leucotoms, Citrus lemon, Citrus sinensis, Citrus paradisi, Quassia amara, Rheum Thais, Rosa canina, Rosmarinus officinalis, Ruscus aculeatus, Salix alba, Salvia officinalis, Salvia rosmarinus, Sesamus indicum, Camelia sinensis, Tilia tomentosa, Thymus vulgaris, Arctostaphylos uva-ursi, Valeriana officinalis, Solidago virgaurea, Loranthus europaeus, Zingiber officinalis.

Preferably, said aromatic plant extract and/or active substance thereof is selected from the group consisting of extracts and/or active substances from extracts of Mentha piperita, Thymus vulgaris, Salvia officinalis, Rosmarinus officinalis, Sesamus indicum, Syzygium aromaticum, Allium sativum, Chrysanthemum cinerariaefolium, Citrus lemon, Cinnamomum verum, Origanum vulgaris, separately or in mixture.

Preferably, said aromatic plant extract and/or active substance thereof may be used for the preparation of the phytotherapeutic composition according to the present invention, as powder or as emulsifiable liquid form.

Preferably, in the phytotherapeutic composition according to the present invention said metal ion is present with respect to the weight of the carbonate substituted hydroxyapatite in a weight ratio from 0.3 to 5, more preferably from 0.5 to 4.5.

Preferably, said metal ion is selected from the group consisting of: Cu, Mg, Zn, B, K, Fe, and Mn, more preferably is selected from the group consisting of: Cu, Zn, B, Fe, and Mn, even more preferably, said metal ion is Cu and/or Zn.

The phytotherapeutic composition according to the present invention may comprise a carboxylic acid as bioactive compound.

Preferably, said carboxylic acid is selected from the group consisting of: a C₉-C₂₂ saturated or unsaturated fatty acid, a C₃-C₈ saturated acid, an hydroxy carboxylic acid, a salt thereof, or a derivative thereof.

Preferably, in the phytotherapeutic composition according to the present invention the carboxylic acids are present with respect to the weight of the carbonate substituted hydroxyapatite, in a weight ratio from 0.01 to 5, more preferably from 0.03 to 3.

Preferably, said carboxylic acid is selected from the group consisting of: Oleic acid, Linoleic acid, Linolenic acid, Arachidonic acid, Beheric acid, Citric acid their sodium, potassium, calcium, glycine salts, their monoglycerides, diglycerides, triglycerides or their mixtures. More preferably, said carboxylic acid is selected from the group consisting of, linoleic acid, linolenic acid, oleic acid as well as their potassium salts, their monoglycerides and diglycerides.

Preferably, the phytotherapeutic composition according to the present invention comprises at least one further component selected from the group consisting of: a surfactant, a dispersant, a thickener, an anti-freezing agent, an anti-mould agent, a penetration enhancer, and a synergist.

Preferably, said at least one further component is present in an amount comprised between 0.1% and 10% by weight, with respect to the total weight of the phytotherapeutic composition.

Preferably, said surfactant is selected from the group consisting of: anionic surfactant or non-ionic surfactant. Said anionic surfactant is preferably selected from the group consisting of dodecylbenzensulphonate and sodium lauryl sarcosinate. Said non-ionic surfactant is preferably selected from the group consisting of ethoxylated tristyrilphenol, ethoxylated fatty alcohol, decyl octyl glicosides.

Preferably, said dispersant is sodium ligninsulphonate.

Preferably, said thickener is xanthan gum.

Preferably, said anti-freezing agent is propylene glycol.

Preferably, said anti-mould agent is benzoisothiazolinone.

Preferably, said penetration enhancer is rapeseed or soybean oil methyl ester.

Preferably, said synergist is piperonyl butoxide.

The present invention relates to the use as phytotherapeutic agent for the endotherapeutic treatment of a plant of a phytotherapeutic composition based on a carbonate substituted hydroxyapatite having the formula (I) above and on aleast one bioactive compound selected from the group consisting of: an aromatic plant extract and/or an active substance thereof, a metal ion, and a carboxylic acid.

In this regard, the Applicant has additionally found out that the phytotherapeutic composition according to the invention is particularly and even more markedly effective for the endotherapeutic treatment of a plant in open environment. In a preferred embodiment, therefore, the endotherapeutic treatment of a plant according to the present invention is carried out in open enviroment.

Preferably, plants that benefit from the endotherapeutic treatment according to the present invention are selected from Tree Crops (e.g. walnuts, almonds, hazelnuts, pistachio etc.), Citrus Trees (e.g. orange, lemon, grapefruit, mandarins etc.) Fruit crops (e.g. pomes, stone fruits or soft fruits, apples, pears, plums, paeches, cherries etc,) Vine Crops (e.g, grapevine), coffee, coconut, pineapple, cocoa, tea, banana, lauroceous plants (e.g. avacados, cinnamom, camphor) fig, guava, mango, olive, papapya, cashew, macadamia, natural rubber tree, data tree (phoenix dactylifera), oil palm tree, ornamentals, forestry (e.g. pine, spruce, eucalyptus, poplar etc), conifers (e.g. loblolly pine, slash pine, ponderosa pine, lodgepole pine, montery pine, Douglas-fir, Western hemlock, sitka spruce, redwood, etc), true firs such as silver fir, balsam fir, cedar, palm trees.

Preferably, the endotherapeutic treatment of a plant according to the present invention is for controlling, preventing or curing an infestation or an attack of an insect, a fungal disease, a bacterial disease, or a phytoplasma disease.

The phytotherapeutic composition according to the present invention shows indeed insecticide activity, antifungal activity, antibacterial activity, and anti-phytoplasma activity.

The phytotherapeutic composition according to the present invention as insecticide can act on a wide range of insects pests. Examples of target insects are insects belonging to Lepidoptera, Coleoptera, Diptera, Thysanoptera, Hymenoptera, Orthoptera, Acarina, Siphonaptera, Thysanura, Chilopoda, Dermaptera, Phtiraptera, Hemiptera, Homopetra, Isoptera, Aptera, Thyenchida, Collembola, Stylommatophora, Ascaridida. The phytotherapeutic composition according to the present invention as antifungal agent can act on a wide range of fungi. Examples of fungal plant diseases are Botrytis cinerea, Ceratocystis, Cercospora, Colletotrichum, Cycloconium, Cylindrocarpon, Esca cause d bu Formitiporia punctata, Formitiporia mediterranea, Phaeomoniella chlamydospora, Phaeoacremonium alephilum, and/or Botryosphaeria obtuse, Elsinoe, Eutypa lata, Cytosposrina lata, Fusarium, Glomerella cingulata, Guignardia bidwellii, Gymnosprangium, Hemileia, Isariopsis clavispora, monilinia, Mycosphaerella, Phialophora, Phomopsis, Phytophora, Plasmopora, Podosphaera, Pseudopezicola tracheiphila, Ramularia, Rhizoctonia, Rhizopus stolonifer, Uncinula necator, Taphrina, Thielaviopsis, Venturia, Verticillium.

The phytotherapeutic composition according to the present invention as antibacterial agent can act on a wide range of bacterial pathogens. Examples of bacterial pathogens are Agrobacterium, Agrobacterium tumefaciens, Erwinia, Erwinia amylovora, Xanthomonas, Xanthomonas campestri, Pseudomonas, Pseudomonas aeruginosa Pseudomonas fluorescens, Pseudomonas putida, Pseudomonas syringae, Rastonia solanacearum, Corynebacterium, Streptomyces, Streptomices scabiae, Actinobacteria, Micoplasmas, Spiroplasma,

The phytotherapeutic composition according to the present invention as anti-phytoplasma agent can act on a wide range of Phytoplasmas. Examples of Phytoplasmas are Ca.Phytoplasma allocasuarinae, Ca. Phytoplasma americanum, Ca. Phytoplasma asteris, Ca. Phytoplasma aurantifolia, Ca. Phytoplasma australasia, Ca. Phytoplasma australiense, Ca. Phytoplasma balanitae, Ca. Phytoplasma brasiliense, Ca. Phytoplasma caricae, Ca. Phytoplasma castaneae, Ca. Phytoplasma convolvuli, Ca. Phytoplasma costaricanum, Ca. Phytoplasma cynodontis, Ca. Phytoplasma fragariae, Ca. Phytoplasma fraxini, Ca. Phytoplasma graminis, Ca. Phytoplasma japonicum, Ca. Phytoplasma lycopersici, Ca. Phytoplasma malaysianum, Ca. Phytoplasma mali, Ca. Phytoplasma omanense, Ca. Phytoplasma oryzae, Ca. Phytoplasma palmicola, Ca. Phytoplasma phoenicium, Ca. Phytoplasma pini, Ca. Phytoplasma pruni, Ca. Phytoplasma prunorum, Ca. Phytoplasma pyri, Ca. Phytoplasma rhamni, Ca. Phytoplasma rubi, Ca. Phytoplasma solani, Ca. Phytoplasma spartii, Ca. Phytoplasma sudamericanum, Ca. Phytoplasma tamaricis, Ca. Phytoplasma trifolii, Ca. Phytoplasma ulmi, Ca. Phytoplasma ziziphi, Ca. Phytoplasma cocosnigeriae, Ca. Phytoplasma cocostanzaniae, Ca. Phytoplasma luffae, Ca. Phytoplasma palmae, Ca. Phytoplasma vitis.

Preferably, in the use according to the present invention, the phytotherapeutic composition is injected in the xylem of said plant after the suitable dilution with water; preferred dilution range for the use according to the invention is from 0.1% to 1.0% (% by weight) with respect to the weight of the phytotherapeutic composition, of the present application. More preferred dilution is from 0.1% to 0.5%, particularly preferred is from 0.1% to 0.15%.

Further features and advantages of the invention will appear more clearly from the following description of some preferred embodiments thereof, made hereinafter by way of a non-limiting example with reference to the following experimental part.

### EXPERIMENTAL PART

### Example 1 (Reference)

### Preparation of Carbonate Substituted Hydroxypatite

The carbonate substituted hydroxyapatite was prepared by mixing 225 g of an aqueous solution of phosphoric acid (obtained from 130 g of phosphoric acid 75% (% w/w) and 96 g of water) and 805 g of a mixture formed by calcium hydroxide (125 g) and calcium carbonate (15 g) previously dispersed in 670 g of water. The mixture was maintained at room temperature for 11 hrs, obtaing a suspension contaning 16% (w/w) of carbonate substituted hydroxyapatite.

### Example 2

Preparation of a Suspension of a Carbonate Substituted Hydroxyapatite Added with Copper and Zinc Salts

100 g of a suspension formed by a 16% (w/w) aqueous suspension of the carbonate substituted hydroxyapatite prepared according to Example 1 was added with 300 g of a 9% (% w/w) aqueous solution of zinc sulfate monohydrate and with 214 g of a 30% (% w/w) of a suspension of tribasic copper sulfate (Cu4SO4(OH)6. ½H2O). 386 g of water were then added, keeping the suspension under stirring for 10 minutes. The suspension thus obtained contained 1.6% of carbonate substituted hydroxyapatite, 1.2% of Zn, expressed as zinc ion and 3.5% of Cu, expressed as copper ion.

### Example 3

Preparation of a Suspension of a Carbonate Substituted Hydroxyapatite Added with Copper and Zinc Salts and a Mixture of Aromatic Plant Extracts

100 g. of the suspension of the carbonate substituted hydroxyapatite according to Example 1, was added, with 300 g of a 9% (% w/w) aqueous solution of zinc sulfate monohydrate and with 214 g of a 30% (% w/w) of a suspension of tribasic copper sulfate (Cu4SO4(OH)6. ½H2O). 50 g. of a 50% (% w/w) ethanol solution containing a mixture of aromatic plant extracts consisting of 30% by weight of mint extract, 26% by weight of rosemary extract, 15% by weight of anise extract, 4% by weight lemon extract, 1% by weight garlic extract, 18% by weight of clove extract, 3% by weight of thyme extract, and 3% by weight of cinnamon extract. All these extracts were commercially available from Calliero S.p.A., Italy. 336 g of water were then added keeping the suspension under stirring for 10 minutes. The suspension thus obtained contained 1.6% of carbonate substituted hydroxyapatite 1.2% of Zn, expressed as zinc ion and 4.9% of Cu, expressed as copper ion and 2.5% of the mixture or aromatic plant extracts.

### Example 4

Preparation of a Suspension of a Carbonate Substituted Hydroxyapatite Added with a Mixture of Aromatic Plant Extracts

100 g. of the suspension of the carbonate substituted hydroxyapatite according to Example 1, were added with 50 g of a 50% (% w/w) ethanol solution containing a mixture of aromatic plant extracts consisting of 30% by weight of mint extract, 26% by weight of rosemary extract, 15% by weight of anise extract, 4% by weight lemon extract, 1% by weight garlic extract, 18% by weight of clove extract, 3% by weight of thyme extract, and 3% by weight of cinnamon extract. All these extracts were commercially available from Calliero S.p.A., Italy. The suspension thus obtained was added with 850 g of water. The suspension thus obtained contained 1.6% of carbonate substituted hydroxyapatite, and 2.5% of the mixture or aromatic plant extracts.

### Comparative Examples

The following products were used as comparative examples:
A. Aqueous suspension containing copper and zinc salts at the same concentration as in Example 2;
B. Aqueous suspension containing copper and zinc salts and a mixture of aromatic plant extracts at the same concentration as in Example 3; and
C. Aqueous suspension containing a mixture of aromatic plant extracts at the same concentration as in Example 4.

### Example 5

### Endotherapeutic Trials

Endotherapeutic trials were carried out on grapevine plants. For each plant tested as positive for Phytoplasma Flavescence dorée, a hole 6 mm in diameter and 15 mm in depth was drilled. 50 ml syringes were attached to the hole. The samples as in Table 1 were diluted at 0.1% (% w/v) and were allowed to be absorbed by the plant. After 24 hours all the plants had absorbed all the liquid. 48 hours after the treatment 6 leaves per plant were collected and maintained at 4° C. until the analysis.

The product used for the treatment were samples from Examples1, 2, 3, 4 and from the comparative Examples A, B and C.

Total nucleic acids were directly extracted from leaf samples and subjected to Droplet Digital PCR (ddRT-PCR) analysis (Peale FV et al., J.Pathology. 195 (1), 7-19, 2001). Leaves were grinded in extraction bags (BIO-REBA) using 1.5 mL of Mackenzie extraction buffer (Mackenzie et al. 1997). The resulting homogenate was diluted with nucleic-free water then an equal volume of a mixture phenol:chloroform:isoamyl alcohol (25:24:1, v/v) was added and stirred by vortex. After centrifugation at 16,000 g for 10 minutes the supernatant was precipitated with 2 volumes of absolute EtOH, 16 μL of 5M sodium chloride and 1 μL of 10 mg/ml glycogen solution. After incubation for 15 min at −20° C. and centrifugation at 16,000 g for 20 min, the pelleted total nucleic acids were washed with 70% EtOH, vacuum dried and then resuspended in 20 μL of nuclease-free water.

Droplet Digital PCR (ddPCR) and one-step ddRT-PCR analyses were performed using ddPCR™ Supermix for Probes (#1863024, Bio-Rad Laboratories) as indicated by manufacturer protocol and added by 2 units of M-MLV Reverse Transcriptase (#M1705, Promega, USA), respectively.

Previously published primers and probe, specific for Ca.Phytoplasma vitis and for plant 18S rRNA (Ratti et al., 2019a), were used in a total reaction volume of 20 μL. After droplet production by a QX200™ Droplet Generator (Bio-Rad Laboratories) the mixture was subjected to the following amplification protocol: 48° C. for 30 min, 95° C. for 5 min, 40 cycles of 95° C. for 30 sec and 60° C. for 1 min, followed by 4° C. for 5 min, and 90° C. for 5 min.

After amplification droplets were streamed and analysed by a QX200 Droplet Reader and QuantaSoft Software (Bio-Rad Laboratories) to identify fluorescent positive and negative droplets and calculate target nucleic acid concentration.

The quantification of 18S rRNA from plant tissues allows to normalize data according to the size of the analysed samples.

Results listed in Table 1 shows the average RNA concentration for Phytoplasma Flavescence dorée after injection of the samples from Example 1,2,3,4 and from the comparative Examples A,B,C.

| | Average RNA |
|---|---|
| Example | Concentration |
| 1 (reference) | 155.47 |
| 2 | 98.39 |
| 3 | 71.81 |
| 4 | 105.95 |
| Comparative A | 170.71 |
| Comparative B | 148.83 |
| Comparative C | 151.78 |
| Water | 158.93 |

The above data show that the composition according to Examples 2-4 according to the invention led to a significant reduction of Phytoplasma Flavescence dorée disease in the treated plant.

1. A method of endotherapeutic treatment of a plant comprising administering to a plant in need thereof as phytotherapeutic agent Use of a phytotherapeutic composition comprising:
a carbonate substituted hydroxyapatite having the formula (I):
Ca_{(10-y/2)}(PO₄)_{(6-y)}(CO₃)_{y}(OH)₂ (I)
wherein y is comprised between 0.01 and 2; and
at least one bioactive compound selected from the group consisting of: an aromatic plant extract and/or an active substance thereof, a metal ion, and a carboxylic acid.

2. The method according to claim 1, wherein y is comprised between 0.1 and 1.2.

3. The method according to claim 2, wherein y is comprised between 0.2 and 0.8.

4. The method according to claim 1, comprising from 0.5% to 40% by weight, with respect to the weight of the phytotherapeutic composition, of said carbonate substituted hydroxyapatite.

5. The method according to claim 1, wherein the carbonate substituted hydroxyapatite has a crystallinity degree comprised between 25% and 59%.

6. The method according to claim 1, wherein the weight ratio of said aromatic plant extract and/or active substance thereof with respect to the weight of the carbonate substituted hydroxyapatite is from 0.1 to 3.

7. The method according to claim 1, wherein said aromatic plant extract and/or active substance thereof is selected from the group consisting of extracts and/or active substances from extracts of Abies sibirica, Malpighia glabra, Achillea millefolium. Allium sativum, Medicago sativa, Aloe vera, Artemisia annua, Arnica Montana, Ocimum basilicum, Betula pendula, Betula pubescens, Calendula officinalis, Chrysanthemum cinerariaefolium, Tanacetum cinerariaefolium, Chrysanthemum coccineum, Chrysanthemum balsamita, Chrysanthemum roseum, Chrysanthemum marshall, Matricaria chamomilla, Chamaemelum nobile, Cinnamomum verum, Centella asiatica, Chelidonium majus, Syzygium aromaticum, Allium cepa, Equisetum arvense, Curcuma longa, Echinacea purpurea, Echinacea angustifolia, Eucalyptus globulus, Hypericum perforatum, Fucus vesiculosus, Glycine max, Glycyrrhiza glabra, Gentiana lutea, Lavandula angustifolia, Linen seed, Melilotus officinalis, Melissa officinalis, Punica granatum, Mentha piperita, Vaccinium myrtillus, Origanum vulgaris, Orthosiphon stamineus, Urtica dioica, Olea europeae, Tabebuia impetiginosa, Plantago lanceolata, Hieracium pilosella, Pinus sibirica, Polypodium leucotoms, Citrus lemon, Citrus sinensis, Citrus paradisi, Quassia amara, Rheum Thais, Rosa canina, Rosmarinus officinalis, Ruscus aculeatus, Salix alba, Salvia officinalis, Salvia rosmarinus, Sesamus indicum, Camelia sinensis, Tilia tomentosa, Thymus vulgaris, Arctostaphylos uva-ursi, Valeriana officinalis, Solidago virgaurea, Loranthus europaeus, Zingiber officinalis.

8. The method according to claim 1, wherein said metal ion is present with respect to the weight of the carbonate substituted hydroxyapatite in a weight ratio from 0.3 to 5.

9. The method according to claim 1, wherein said metal ion is selected from the group consisting of: Cu, Mg, Zn, B, K, Fe, and Mn.

10. The method according to claim 1, wherein said carboxylic acid is selected from the group consisting of: a C₉-C₂₂ saturated or unsaturated fatty acid, a C₃-C₈ saturated acid, a hydroxy carboxylic acid, a salt thereof, or a derivative thereof.

11. The method according to claim 1, wherein said carboxylic acid is present with respect to the weight of the carbonate substituted hydroxyapatite, in a weight ratio from 0.01 to 5.

12. The method according to claim 1, wherein said plant is selected from the group consisting of tree crops, citrus trees, fruit crops, vine crops, coffee, coconut, pineapple, cocoa, tea, banana, lauroceous plants, fig, guava, mango, olive, papapya, cashew, macadamia, natural rubber tree, data tree, oil palm tree, ornamentals, forestry, conifers, true firs, cedar, palm trees.

13. The method according to claim 1, wherein said endotherapeutic treatment of a plant is for controlling, preventing or curing an infestation or an attack of an insect, a fungal disease, a bacterial disease, or a phytoplasma disease.

14. The method according to claim 1, wherein for said endothepic treatment the phytotherapeutic composition is injected in the xylem of said plant after dilution with water at a dilution range from 0.1% to 1.0% (% by weight) with respect to the weight of the phytotherapeutic composition.
